(19) United States
(12) Patent Application Publication
(10) Pub. No.: US 2017/0080756 A1
(43) Pub. Date: Mar. 23, 2017

(54) NON-PNEUMATIC TIRE

(71) Applicant: THE GOODYEAR TIRE & RUBBER COMPANY, Akron, OH (US)

(72) Inventors: Philip Carl VAN RIPER, Cuyahoga Falls, OH (US); Joseph Carmine LETTIERI, Hudson, OH (US); Rebecca Anne BANDY, Cuyahoga Falls, OH (US); Addison Brian SIEGEL, Cuyahoga Falls, OH (US); Mahdy MALEKZADEH MOGHANI, Cuyahoga Falls, OH (US)

(21) Appl. No.: 15/237,961

(22) Filed: Aug. 16, 2016

Related U.S. Application Data
(60) Provisional application No. 62/220,036, filed on Sep. 17, 2015.

(51) Int. Cl. B60C 7/14; B60B 9/26

(52) U.S. Cl. CPC B60C 7/14; B60B 9/26; B60C 2007/146; B60B 2900/115

(57) ABSTRACT

A structurally supported tire includes a ground contacting annular tread portion, an annular shear band and two or more spokes.

### FIELD OF THE INVENTION

The present invention relates generally to vehicle tires and non-pneumatic tires, and more particularly, to a non-pneumatic tire.

### BACKGROUND OF THE INVENTION

The pneumatic tire has been the solution of choice for vehicular mobility for over a century. The pneumatic tire is a tensile structure. The pneumatic tire has at least four characteristics that make the pneumatic tire so dominate today. Pneumatic tires are efficient at carrying loads, because all of the tire structure is involved in carrying the load. Pneumatic tires are also desirable because they have low contact pressure, resulting in lower wear on roads due to the distribution of the load of the vehicle. Pneumatic tires also have low stiffness, which ensures a comfortable ride in a vehicle. The primary drawback to a pneumatic tire is that it requires compressed fluid. A conventional pneumatic tire is rendered useless after a complete loss of inflation pressure.

A tire designed to operate without inflation pressure may eliminate many of the problems and compromises associated with a pneumatic tire. Neither pressure maintenance nor pressure monitoring is required. Structurally supported tires such as solid tires or other elastomeric structures to date have not provided the levels of performance required from a conventional pneumatic tire. A structurally supported tire solution that delivers pneumatic tire-like performance would be a desirous improvement.

Non pneumatic tires are typically defined by their load carrying efficiency. “Bottom loaders” are essentially rigid structures that carry a majority of the load in the portion of the structure below the hub. “Top loaders” are designed so that all of the structure is involved in carrying the load. Top loaders thus have a higher load carrying efficiency than bottom loaders, allowing a design that has less mass.

Thus an improved non pneumatic tire is desired that has all the features of the pneumatic tires without the drawback of the need for air inflation is desired.

### BRIEF DESCRIPTION OF THE DRAWINGS

The present invention will be better understood through reference to the following description and the appended drawings, in which:

FIG. 1 is a perspective view of a first embodiment of a non-pneumatic tire of the present invention;

FIG. 2 is a perspective view of a spoke disk of the present invention;

FIG. 3 is a schematic cross section view of the spoke disk of FIG. 2;

FIG. 4 is a front view of the spoke disk of FIG. 2;

FIG. 5 is a cross-sectional view of the non-pneumatic tire of FIG. 1;

FIG. 6 is an alternate embodiment of a spoke disk of the present invention;

FIG. 7 is an alternate embodiment of a spoke disk of the present invention;

FIG. 8 is a cross-sectional view of an alternate embodiment of a non-pneumatic tire of the present invention illustrating multiple spoke disks with the same orientation;

FIG. 9 is a cross-sectional view of the non-pneumatic tire of FIG. 1, shown with two spoke disks in opposed orientation so that the spokes bow axially inward when under load.

FIG. 10 is a cross-sectional view of the non-pneumatic tire of FIG. 1 shown with two disk spokes having a different orientation so that the spokes bow axially outward when under load.

FIG. 11 is a cross-sectional view of the non-pneumatic tire of FIG. 1 shown with the disk spokes having a curved cross-section, shown under load.

FIG. 12a illustrates a spring rate test for a shear band, while FIG. 12b illustrates the spring rate k determined from the slope of the force displacement curve.

FIG. 13a illustrates a spring rate test for a spoke disk, while FIG. 13b illustrates the spring rate k determined from the slope of the force displacement curve.

FIG. 14A illustrates a test specimen undergoing shear, while FIG. 14B illustrates the pure shear test.

FIG. 15A illustrates a spring rate test for the non-pneumatic tire, while FIG. 15B illustrates the tire spring rate k being determined from the slope of the force displacement curve.

FIG. 16 is the deflection measurement on a shear band from a force F.

### DEFINITIONS

The following terms are defined as follows for this description.

“Equatorial Plane” means a plane perpendicular to the axis of rotation of the tire passing through the centerline of the tire.

“Meridian Plane” means a plane parallel to the axis of rotation of the tire and extending radially outward from said axis.

“Hysteresis” means the dynamic loss tangent measured at 10 percent dynamic shear strain and at 25° C.

### DETAILED DESCRIPTION OF THE INVENTION

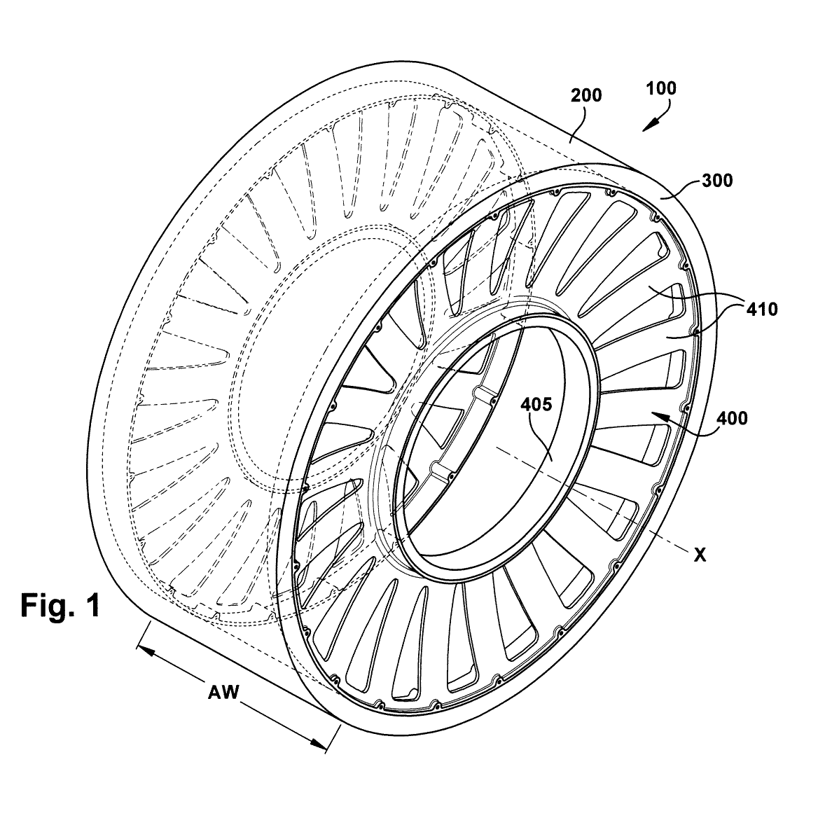

The non-pneumatic tire 100 of the present invention is shown in FIG. 1. The tire of the present invention includes a radially outer ground engaging tread 200, a shear band 300, and one or more spoke disks 400. The non-pneumatic tire of the present invention is designed to be a top loading structure, so that the shear band 300 and the one or more spoke disks 400 efficiently carry the load. The shear band 300 and the spoke disks 400 are designed so that the stiffness of the shear band is directly related to the spring rate of the tire. The spokes of each disk are designed to be stiff structures that buckle or deform in the tire footprint and do not compress or carry a compressive load. This allows the rest of the spokes not in the footprint area the ability to carry the load. Since there are more spokes outside of the footprint than in, the load per spoke would be small enabling smaller spokes to carry the tire load which gives a very load efficient structure. Not all spokes will be able to elastically buckle and will retain some portion of the load in compression in the footprint. It is desired to minimize this load for the reason above and to allow the shearband to bend to overcome road obstacles. The approximate load distribution is such that approximately 90-100% of the load is carried by the shear band and the upper spokes, so that the lower spokes carry virtually zero of the load, and preferably less than 10%.

The tread portion 200 may have no grooves or may have a plurality of longitudinally oriented tread grooves forming essentially longitudinal tread ribs there between. Ribs may be further divided transversely or longitudinally to form a tread pattern adapted to the usage requirements of the particular vehicle application. Tread grooves may have any depth consistent with the intended use of the tire. The tire tread 200 may include elements such as ribs, blocks, lugs, grooves, and sipes as desired to improve the performance of the tire in various conditions.

### Shear Band

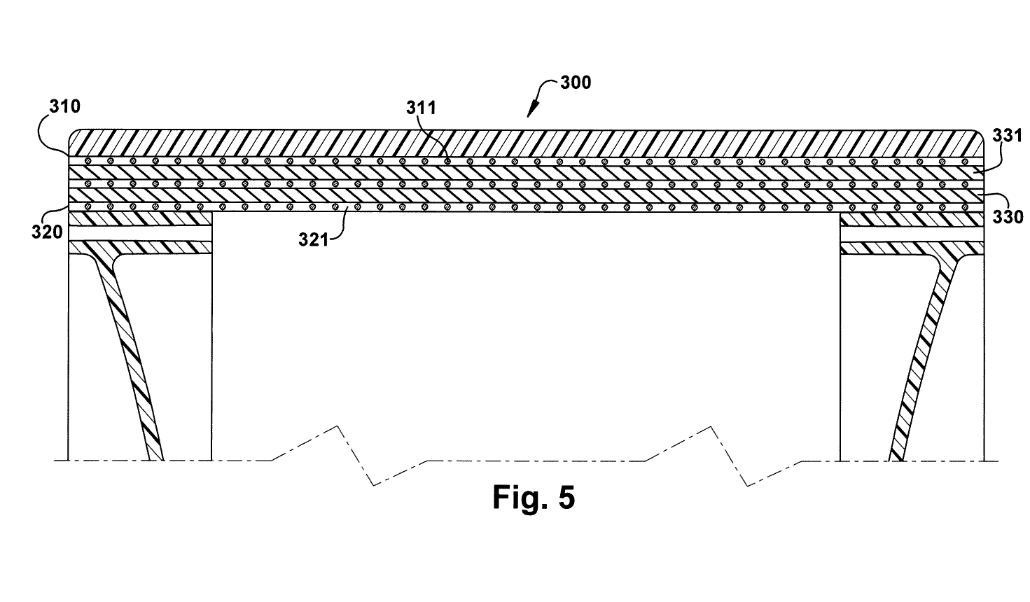

The shear band 300 is preferably annular, and is shown in FIG. 5. The shear band 300 is located radially inward of the tire tread 200. The shear band 300 includes a first and second reinforced elastomer layer 310,320. In a first embodiment of a shear band 300, the shear band is comprised of two inextensible layers arranged in parallel, and separated by a shear matrix 330 of elastomer. Each inextensible layer 310,320 may be formed of parallel inextensible reinforcement cords 311,321 embedded in an elastomeric coating. The reinforcement cords 311,321 may be steel, aramid, or other inextensible structure. In a second embodiment of the shear band, the shear band 300 further includes a third reinforced elastomer layer located between the first and second reinforced elastomer layers 310,320.

In the first reinforced elastomer layer 310, the reinforcement cords 311 are oriented at an angle Φ in the range of 0 to about +/−10 degrees relative to the tire equatorial plane. In the second reinforced elastomer layer 320, the reinforcement cords 321 are oriented at an angle φ in the range of 0 to about +/−10 degrees relative to the tire equatorial plane. Preferably, the angle Φ of the first layer is in the opposite direction of the angle φ of the reinforcement cords in the second layer. That is, an angle+Φ in the first reinforced elastomeric layer and an angle−φ in the second reinforced elastomeric layer.

The shear matrix 330 has a thickness in the range of about 0.10 inches to about 0.2 inches, more preferably about 0.15 inches. The shear matrix is preferably formed of an elastomer material having a shear modulus G in the range of 2.5 to 40 MPa, and more preferably in the range of 20 to 40 MPA. The shear modulus G may be determined using the pure shear test, as shown in FIG. 14.

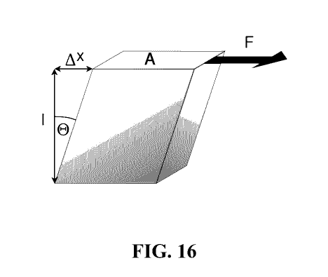

The shear band has a shear stiffness GA. The shear stiffness GA may be determined by measuring the deflection on a shear band from a force F as shown in FIG. 16, and then calculating from the following equation:

GA=F*L/ΔX

The shear band has a bending stiffness EI. The bending stiffness EI may be determined from beam mechanics using the three point bending test. It represents the case of a beam resting on two roller supports and subjected to a concentrated load applied in the middle of the beam. The bending stiffness EI is determined from the following equation: EI=PL³/48*ΔX, where P is the load, L is the beam length, and ΔX is the deflection.

It is desirable to maximize the bending stiffness of the shearband EI and minimize the shear band stiffness GA. The acceptable ratio of GA/EI would be between 0.01 and 20, with an ideal range between 0.01 and 5. EA is the extensible stiffness of the shear band, and it is determined experimentally by applying a tensile force and measuring the change in length. The ratio of the EA to EI of the shearband is acceptable in the range of 0.02 to 100 with an ideal range of 1 to 50.

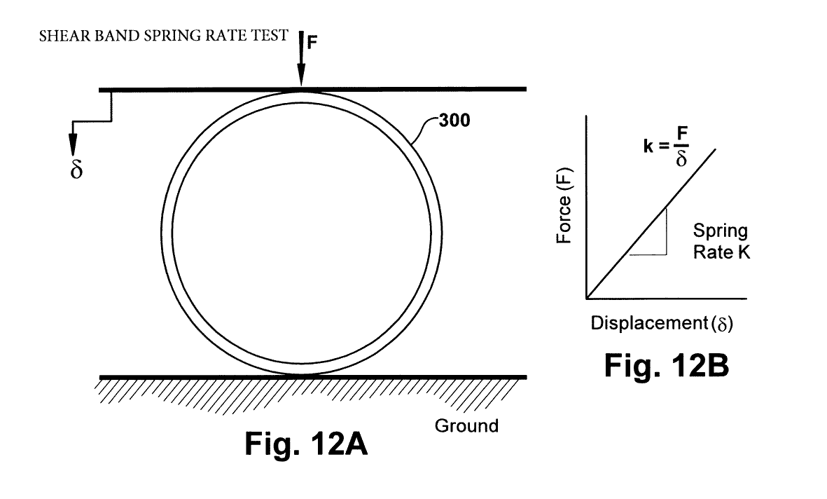

The shear band has a spring rate k that may be determined experimentally by exerting a downward force on a horizontal plate at the top of the shear band and measuring the amount of deflection as shown in FIG. 12. The spring rate is determined from the slope of the Force versus deflection curve.

In an alternative embodiment, the shear band may comprise any structure which has the above described ratios of GA/EI, EA/EI and spring rate. The tire tread is preferably wrapped about the shear band and is preferably integrally molded to the shear band.

### Spoke Disk

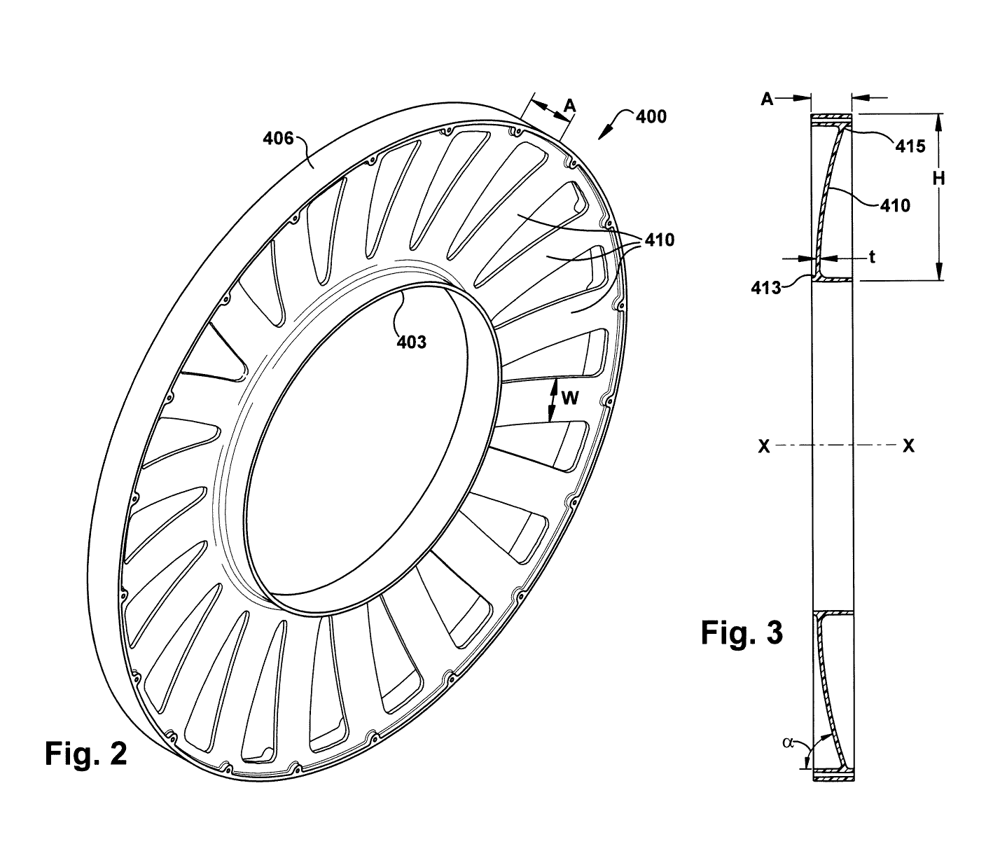

The non-pneumatic tire of the present invention further includes at least one spoke disk 400, and preferably at least two disks 400 which are spaced apart at opposed ends of the non-pneumatic tire as shown in FIGS. 1, 9 and 10. The spoke disk 400 functions to carry the load transmitted from the shear layer. The disks are primarily loaded in tension and shear, and carry no load in compression. As shown in FIG. 2, the disk 400 is annular, and has an outer edge 406 and an inner edge 403 for receiving a metal or rigid reinforcement ring 405 to form a hub. Each disk 400 has an axial thickness A that is substantially less than the axial thickness AW of the non-pneumatic tire. The axial thickness A is in the range of 5-20% of AW, more preferably 5-10% AW. If more than one disk is utilized, than the axial thickness of each disk may vary or be the same.

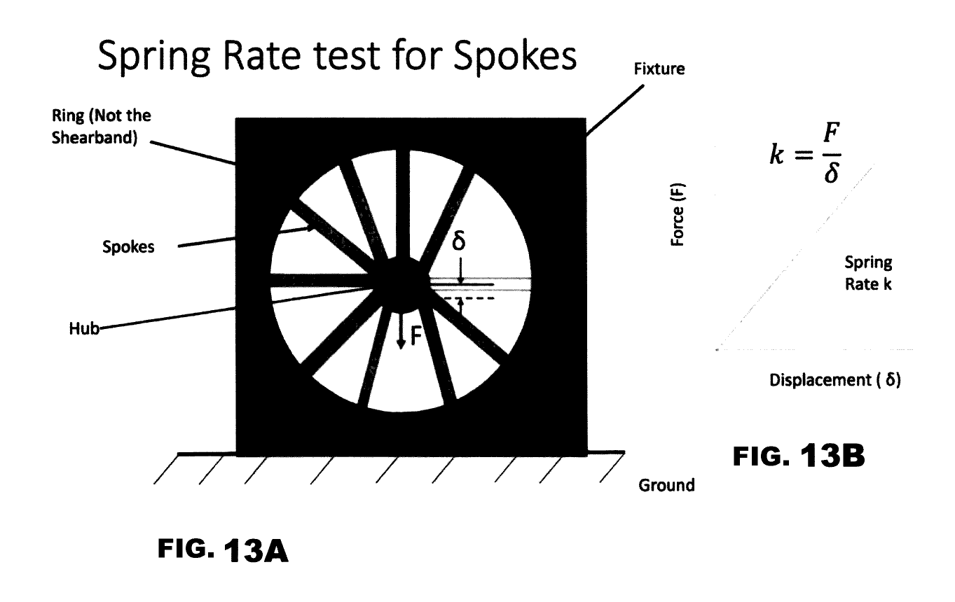

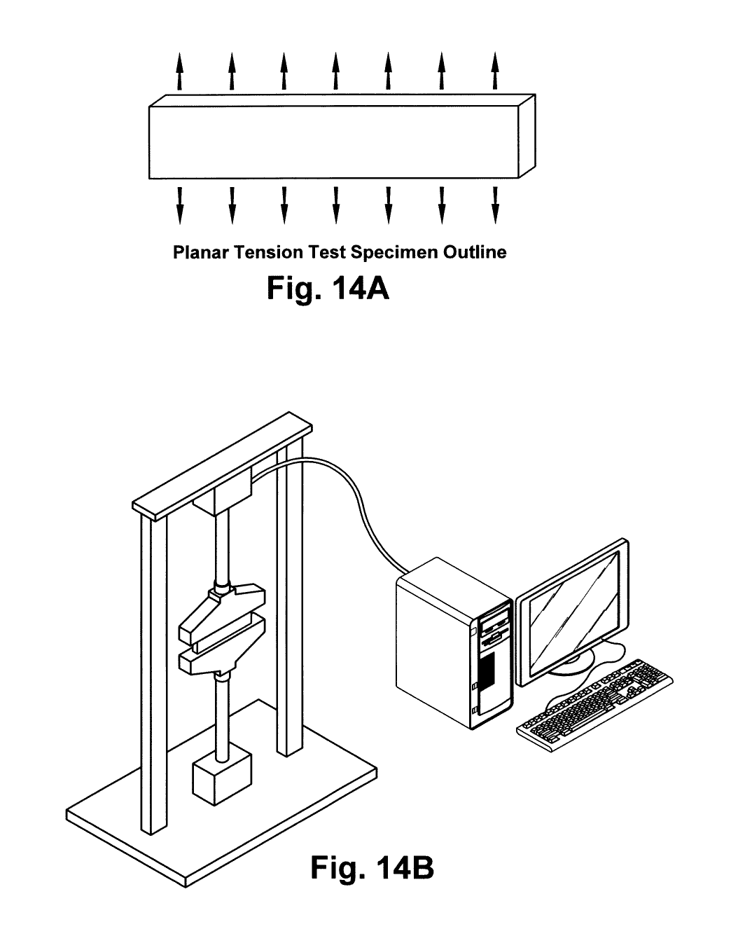

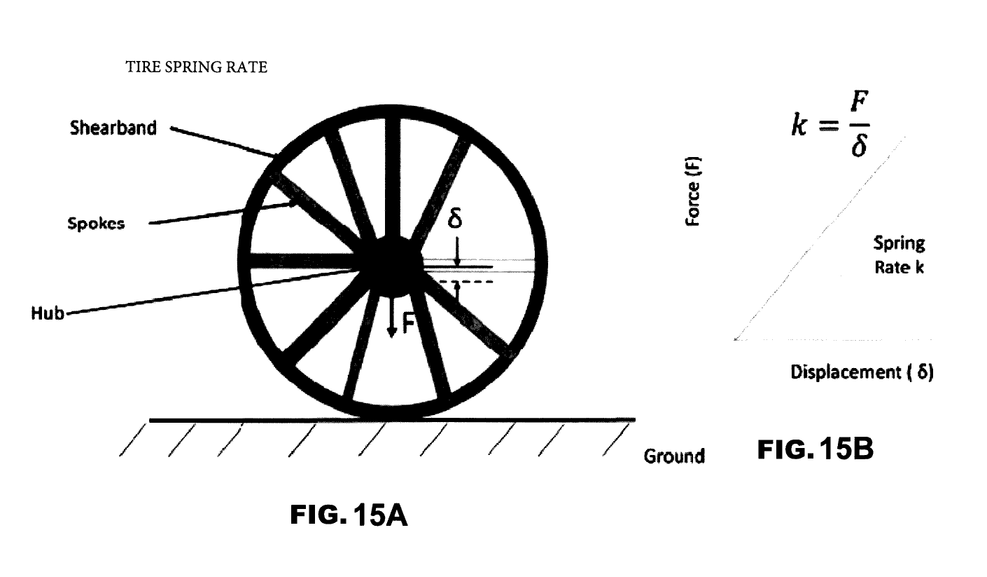

Each spoke disk 400 has a spring rate SR which may be determined experimentally by measuring the deflection under a known load, as shown in FIG. 13a. One method for determining the spoke disk spring rate k is to mount the spoke disk to a hub, and attaching the outer ring of the spoke disk to a rigid test fixture. A downward force is applied to the hub, and the displacement of the hub is recorded. The spring rate k is determined from the slope of the force deflection curve as shown in FIG. 13b. It is preferred that the spoke disk spring rate be greater than the spring rate of the shear band. It is preferred that the spoke disk spring rate be in the range of 4 to 12 times greater than the spring rate of the shear band, and more preferably in the range of 6 to 10 times greater than the spring rate of the shear band.

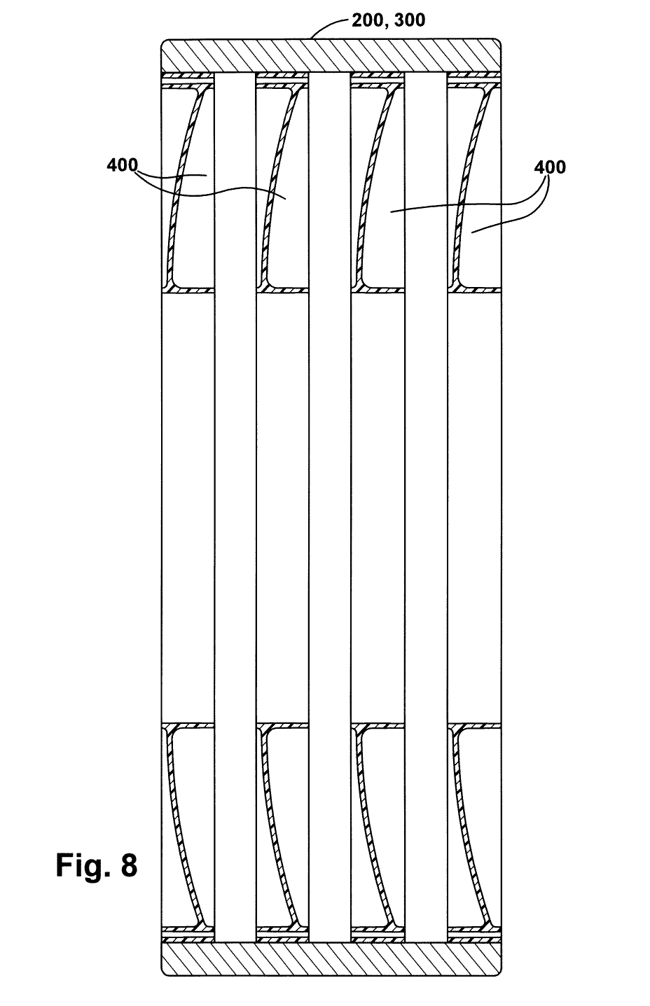

Preferably, if more than one spoke disk is used, all of the spoke disks have the same spring rate. The spring rate of the non-pneumatic tire may be adjusted by increasing the number of spoke disks as shown in FIG. 8. Alternatively, the spring rate of each spoke disk may be different by varying the geometry of the spoke disk or changing the material. It is additionally preferred that if more than one spoke disk is used, that all of the spoke disks have the same outer diameter.

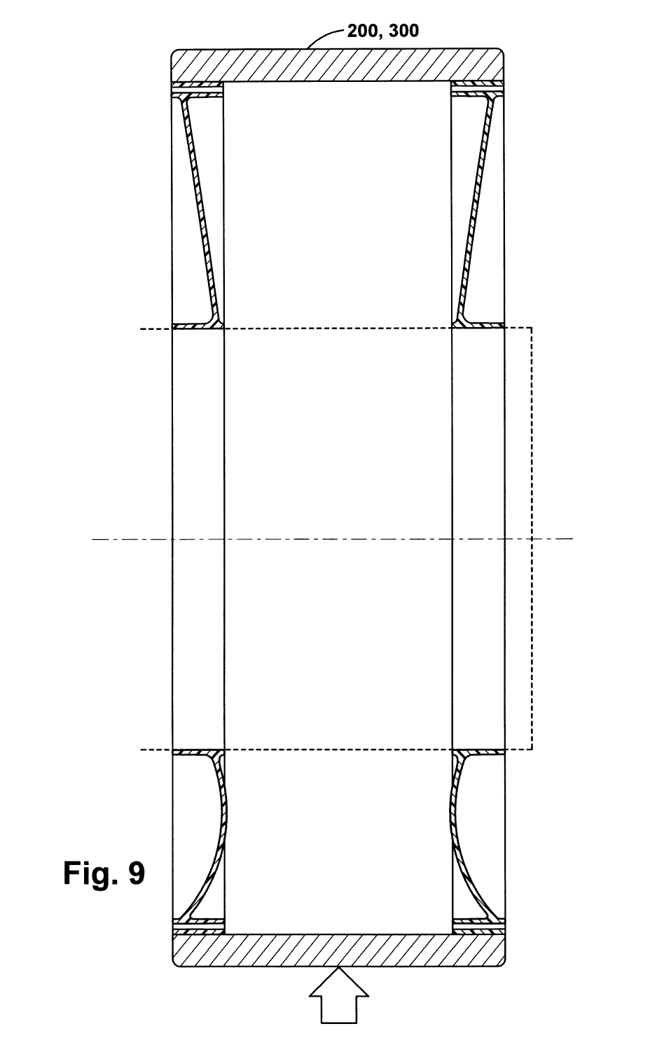

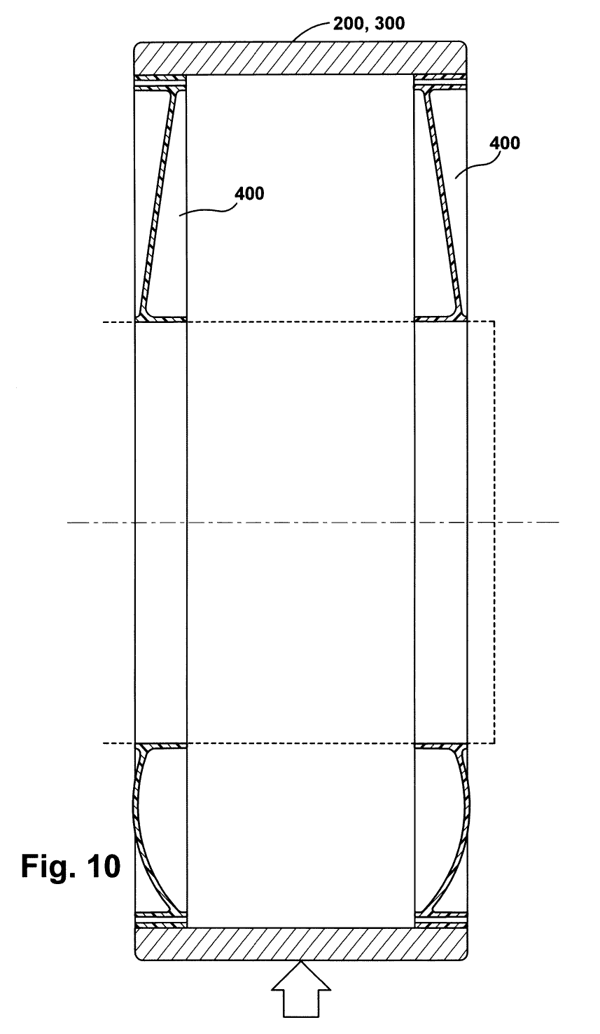

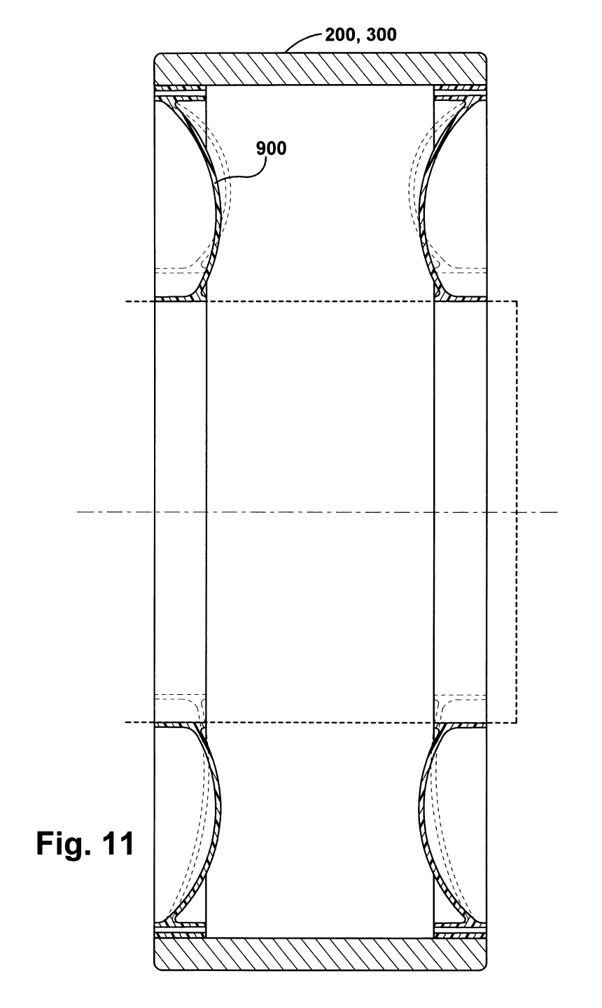

FIG. 8 illustrates an alternate embodiment of a non-pneumatic tire having multiple spoke disks 400. The spokes 410 preferably extend in the radial direction. The spoke disks 400 are preferably oriented so that all of the spoke disks bend in the same direction. The spokes of the present invention are designed to bulge or deform in an axial direction, so that each spoke deforms axially outward as shown in FIG. 10 or axially inward as shown in FIG. 9. If only two spoke disks are used, the spoke disks may be oriented so that each spoke disk bulges or deforms axially inward as shown in FIG. 9, or the opposite orientation such that the spoke disks bulge axially outward as shown in FIG. 10. When the non-pneumatic tire is loaded, the spokes will deform or axially bow when passing through the contact patch with substantially no compressive resistance, supplying zero or insignificant compressive force to load bearing. The predominant load of the spokes is through tension and shear, and not compression.

The spokes have a rectangular cross section as shown in FIG. 1, but are not limited to a rectangular cross-section, and may be round, square, elliptical, etc. Preferably, the spoke cross-sectional geometry is selected for longitudinal buckling, and preferably have a spoke width W to spoke axial thickness ratio, W/t, in the range of about 15 to about 80, and more preferably in the range of about 30 to about 60 and most preferably in the range of about 45 to about 55. A unique aspect of the preferred rectangular spoke design is the ability of the spokes to carry a shear load, which allows the spring stiffness to be spread between the spokes in tension and in shear loading. This geometric ability to provide shear stiffness is the ratio between the spoke thickness t and the radial height H of the spoke. The preferred ratio of H/t is in the range of about 2.5 and 25 (about means +/−10%) and more preferably in the range of about 10 to 20 (about means +/−10%), and most preferably in the range of 12-17.

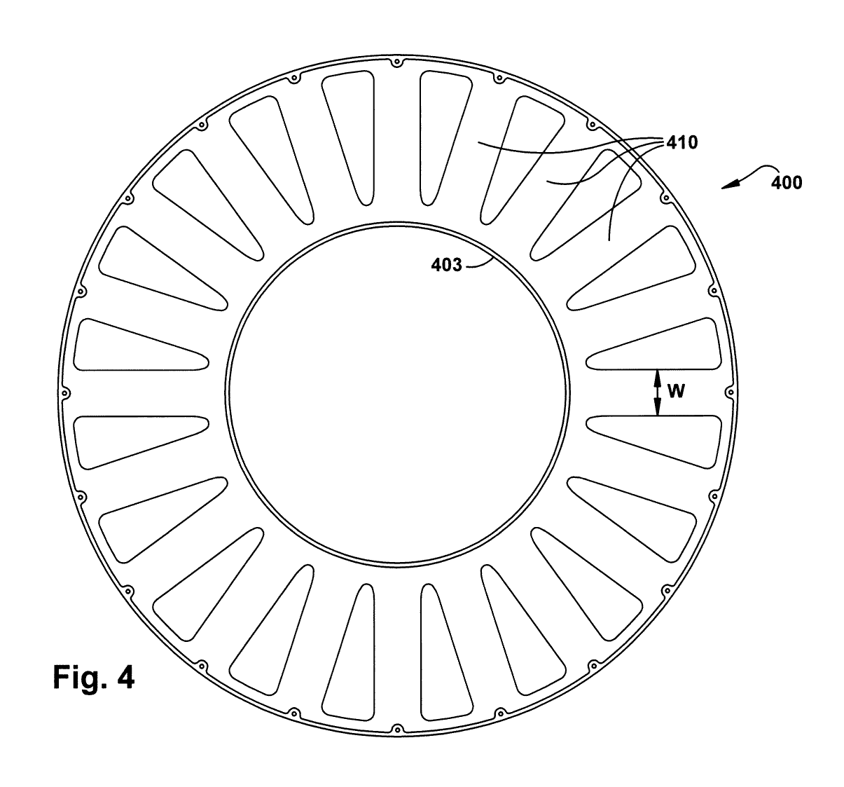

The spokes preferably are angled in the radial plane at an angle alpha as shown in FIG. 3. The angle alpha is preferably in the range of 60 to 88 degrees, and more preferably in the range of 70 to 85 degrees. Additionally, the radially outer end 415 is axially offset from the radially inner end 413 of spoke 410 to facilitate the spokes bowing or deforming in the axial direction. Alternatively, the spokes 900 may be curved as shown in FIG. 11.

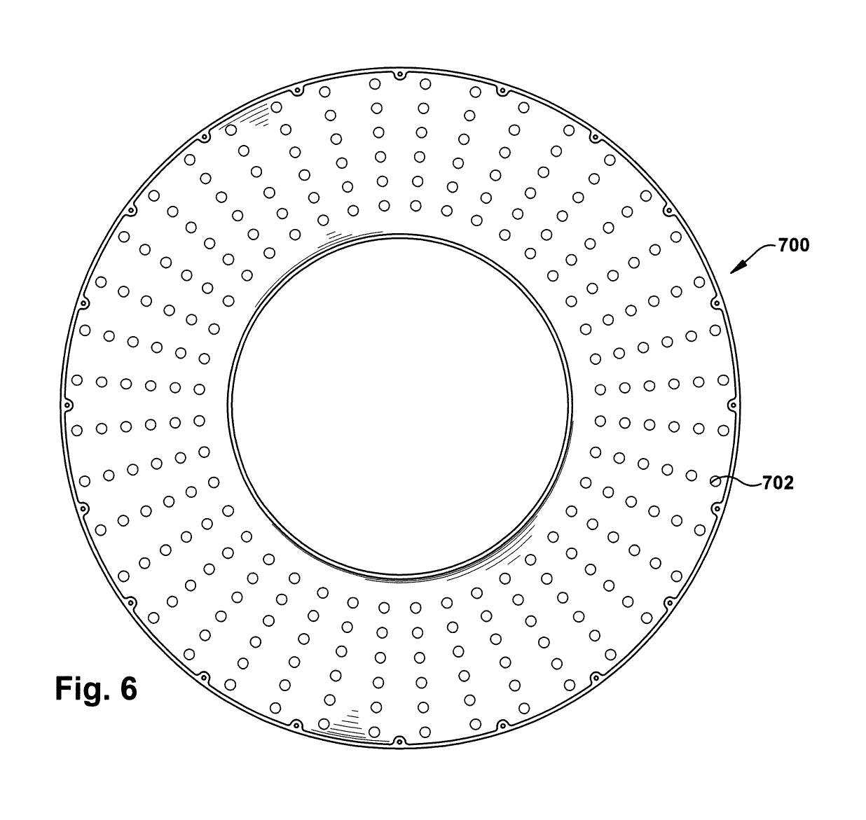

FIG. 6 is an alternate embodiment of a spoke disk 700. The spoke disk is annular, and primarily solid with a plurality of holes 702. The holes may be arranged in rows oriented in a radial direction.

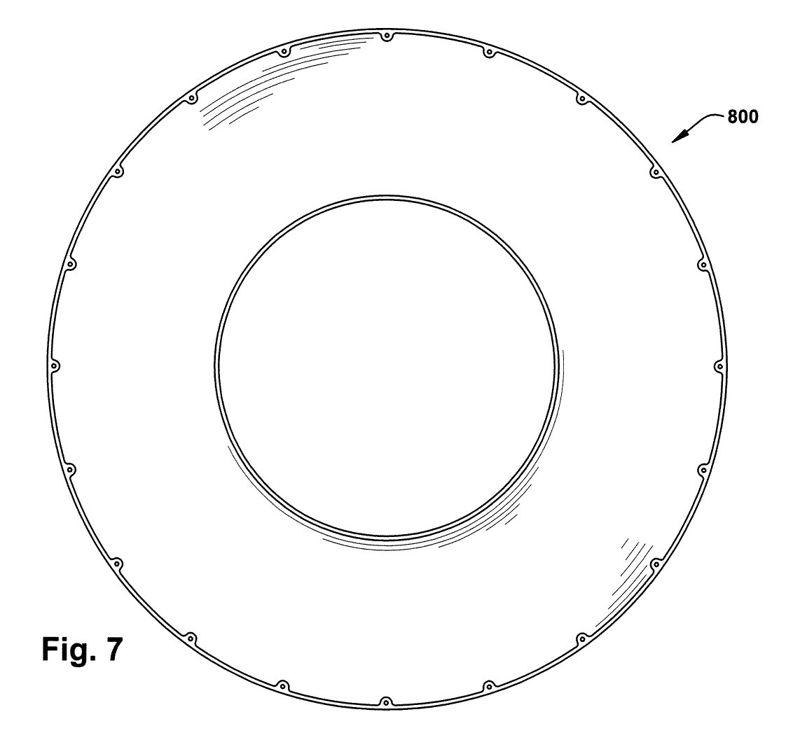

FIG. 7 is an alternate embodiment of a spoke disk 800. The spoke disk in annular and solid, with no holes. The cross-section of the spoke disk 700, 800 is the same as FIG. 3. The spoke disks 700, 800 have the same thickness, axial width as shown in FIG. 3.

The spoke disks are preferably formed of an elastic material, more preferably, a thermoplastic elastomer. The material of the spoke disks is selected based upon one or more of the following material properties. The tensile (Young's) modulus of the disk material is preferably in the range of 45 MPa to 650 MPa, and more preferably in the range of 85 MPa to 300 MPa, using the ISO 527-1/-2 standard test method. The glass transition temperature is less than −25 degree Celsius, and more preferably less than −35 degree Celsius. The yield strain at break is more than 30%, and more preferably more than 40%. The elongation at break is more than or equal to the yield strain, and more preferably, more than 200%. The heat deflection temperature is more than 40 degree C. under 0.45 MPa, and more preferably more than 50 degree C. under 0.45 MPa. No break result for the Izod and Charpy notched test at 23 degree C. using the ISO 17911S0180 test method. Two suitable materials for the disk is commercially available by DSM Products and sold under the trade name ARNITEL PM 420 and ARNITEL P1461.

Applicants understand that many other variations are apparent to one of ordinary skill in the art from a reading of the above specification. These variations and other variations are within the spirit and scope of the present invention as defined by the following appended claims.

What is claimed:

1. A structurally supported non-pneumatic tire comprising
a ground contacting annular tread portion;
a shear band;
at least one spoke disk connected to the shear band, wherein the spoke disk has at least one spoke, wherein the spring rate of the spoke disk is greater than the spring rate of the shear band.

2. The structurally supported non-pneumatic tire of claim 1 wherein the spoke has an axial thickness less than the axial thickness of the spoke disk.

3. The structurally supported non-pneumatic tire of claim 1 wherein the axial thickness of the spoke is less than the width of the spoke.

4. The structurally supported non-pneumatic tire of claim 1 further comprising a second spoke disk, wherein each spoke disk is located on each axial end of the non-pneumatic tire.

5. The structurally supported non-pneumatic tire of claim 4 wherein the spoke disks have the same stiffness.

6. The non-pneumatic tire of claim 4 wherein the spoke disks have the same outer diameter.

7. The non-pneumatic tire of claim 4 wherein the spoke disks are made of the same material.

8. The non-pneumatic tire of claim 1 wherein said spoke disk is a solid annular disk having no holes.

9. The non-pneumatic tire of claim 1 wherein said spoke disk is a solid annular disk having one or more holes.

10. The non-pneumatic tire of claim 9 wherein said spoke disk has a plurality of holes arranged in radially oriented rows.

11. The non-pneumatic tire of claim 1 wherein said spoke disk has a plurality of radially oriented spokes.

12. The non-pneumatic tire of claim 1 wherein the ratio of the axial thickness of the non-pneumatic tire AW to the axial thickness of the spoke disk A is in the range of about 4 to 10, more preferably 6 to 8.

13. The non-pneumatic tire of claim 1 wherein the spokes are angled at an angle alpha with respect to the axial direction in the range of 60-80 degrees.

14. The non-pneumatic tire of claim 1 wherein the ratio W/t of the width W of each spoke to the axial thickness t is in the range 15 to 80.

15. The non-pneumatic tire of claim 1 wherein the ratio of the height of each spoke H to the axial thickness t is in the range of about 2.5 to 25.

16. The non-pneumatic tire of claim 1 wherein the spoke radially outer end is axially offset from the radially inner end of the spoke.

17. The non-pneumatic tire of claim 1 wherein the spoke is curved from the radially outer end to the radially inner end.

18. The non-pneumatic tire of claim 1 wherein the spokes bow under load in the axial direction.

19. The non-pneumatic tire of claim 1 wherein a spoke of the spoke disk has a rectangular cross-section.

20. The non-pneumatic tire of claim 1 wherein the spring rate of the spoke disks is in the range of 4 to 12 times greater than the spring rate of the shear band.

21. A non-pneumatic tire comprising
a ground contacting annular tread portion;
a shear band; and
at least one spoke disk connected to the shear band, wherein the spoke disk has one or more spokes, wherein the spoke has a width W and an axial thickness t, wherein the ratio of W/t is in the range between 15 and 80.

22. The non-pneumatic tire of claim 21 wherein said spoke has a rectangular cross-section.

23. The non-pneumatic tire of claim 21 wherein said spokes extend in the radial direction.

24. The non-pneumatic tire of claim 21 wherein the spring rate of the spoke disk is greater than the shear band spring rate.

25. The structurally supported non-pneumatic tire of claim 21 wherein the ratio of W/t is in the range between 30 and 60.

26. The structurally supported non-pneumatic tire of claim 21 wherein the spring rate of the spoke disks is in the range of 4 to 12 times greater than the spring rate of the shear band.

27. The structurally supported non-pneumatic tire of claim 1 or 21 wherein there are a plurality of spoke disks, and wherein the spring rate of all of the spoke disks is greater than the spring rate of the shear band.

28. The structurally supported non-pneumatic tire of claim 1 or 21 wherein the spokes are curved.

29. A structurally supported non-pneumatic tire comprising
a ground contacting annular tread portion;
a shear band; and
at least one spoke disk connected to the shear band, wherein the spoke has an axial thickness less than the axial thickness of the spoke disk.

30. The structurally supported non-pneumatic tire of claim 29 wherein a spring rate of the spoke disk is greater than a spring rate of the shear band.

31. The structurally supported non-pneumatic tire of claim 29 wherein the ratio of the spoke disk axial thickness A to the spoke axial thickness t is in the range of 6 to 11.
